(19) United States
(12) Patent Application Publication
(10) Pub. No.: US 2024/0351483 A1
(43) Pub. Date: Oct. 24, 2024

(54) ELECTRIC ACTUATOR

(71) Applicant: TOYOTA BOSHOKU KABUSHIKI KAISHA, Aichi (JP)

(72) Inventor: Sadao ITO, Anjo-shi (JP)

(73) Assignee: TOYOTA BOSHOKU KABUSHIKI KAISHA, Aichi (JP)

(21) Appl. No.: 18/637,704

(22) Filed: Apr. 17, 2024

(30) Foreign Application Priority Data
Apr. 19, 2023 (JP) 2023-068516

(51) Int. Cl. B60N 2/02

(52) U.S. Cl. CPC B60N 2/02253

(57) ABSTRACT

In an electric actuator, at least a part of an electric motor projected on an imaginary plane orthogonal to a rotational axis of a worm wheel overlaps at least one of a worm projected on the imaginary plane or the worm wheel projected on the imaginary plane.

### CROSS-REFERENCE TO RELATED APPLICATIONS

The present application claims the benefit of Japanese Patent Application No. 2023-068516 filed on Apr. 19, 2023 with the Japan Patent Office, the entire disclosure of which is incorporated herein by reference.

### BACKGROUND

The present disclosure relates to an electric actuator that operates a movable portion of a vehicle seat.

For example, Japanese Unexamined Patent Application Publication No. 2003-285665 (Patent Document 1) discloses an electric actuator comprising an electric motor, a first gear reducer with two spur gears, and a second gear reducer with a worm and a worm wheel, in which the electric motor is arranged on an opposite side to the worm wheel across the worm.

### SUMMARY

In the electric actuator disclosed in Patent Document 1, the electric motor is arranged on the opposite side to the worm wheel across the worm. Therefore, the electric actuator has outer dimensions of a total or more of respective outer dimensions of the electric motor, the worm, and the worm wheel. The outer dimensions mean outer dimensions of each component when each component is projected on an imaginary plane orthogonal to a rotational axis of the worm wheel.

In view of the foregoing point, the present disclosure discloses examples of an electric actuator that can be smaller in outer dimensions as compared to the electric actuator disclosed in Patent Document 1.

Preferably, an electric actuator that operates a movable portion of a vehicle seat comprises, for example, at least one of constituent elements to be described below.

Specifically, the constituent elements comprise: an electric motor; a first gear provided to an output shaft of the electric motor; a second gear meshing with the first gear and having a rotational axis parallel to a rotational axis of the output shaft; a worm that is configured to receive a driving force from the second gear to thereby rotate and has a rotational axis parallel to the rotational axis of the output shaft; a worm wheel meshing with the worm and having a rotational axis parallel to a direction orthogonal to the rotational axis of the output shaft; and an output portion that is configured to receive a driving force from the worm wheel to thereby output a rotational force and has a rotational axis parallel to the rotational axis of the worm wheel. At least a part of the electric motor projected on an imaginary plane orthogonal to the rotational axis of the worm wheel overlaps at least one of the worm projected on the imaginary plane or the worm wheel projected on the imaginary plane.

Consequently, the electric actuator has smaller outer dimensions as compared to the electric actuator disclosed in Patent Document 1 since the at least a part of the electric motor projected on the imaginary plane overlaps at least one of the worm projected on the imaginary plane or the worm wheel projected on the imaginary plane.

The electric actuator may have, for example, a configuration below. Specifically and preferably, the electric actuator comprises a gear casing accommodating therein, the second gear, the worm, and the worm wheel, and the electric motor is supported by the gear casing such that the electric motor is arranged outside the gear casing.

As compared to a configuration of accommodating the electric motor inside the gear casing, the above configuration allows easier thermal dissipation when heat is generated in the electric motor and can inhibit accumulation of the heat inside the gear casing. Accordingly, thermal degradation of lubricant or the like encapsulated inside the gear casing can be inhibited.

Preferably, the electric actuator comprises two or more support portions supporting the electric motor. The two or more support portions comprises a first support portion arranged on an output shaft side with respect to a motor main body of the electric motor and a second support portion arranged on an opposite side to the output shaft with respect to the motor main body.

The foregoing arrangement allows a configuration where the electric motor having a relatively large mass is supported on one side and on the other side of the motor main body. Consequently, this configuration can suppress excessive increase in a maximum vibration amplitude of a vibration generated in the electric motor and a maximum vibration amplitude of the electric motor vibrating due to an exciting force applied to the electric motor from an outside via the vehicle seat.

Preferably, the support portion has a configuration of supporting the motor main body via an elastic member. Such a configuration allows absorbance of dimensional variations of the two or more support portions and the above vibrations.

Preferably, the electric actuator comprises a slide bearing that rotatably supports a leading end side of the output shaft and that is fixed to the gear casing. Such a configuration can ensure that the first gear and the second gear remain properly meshing with each other over a long period of time.

Preferably, the electric motor is a direct current motor comprising a commutator and a brush inside the motor main body on an opposite side to the output shaft with respect to the motor main body. Consequently, even if a lubricant encapsulated inside the gear casing enters the motor main body, it can be inhibited from reaching the commutator and the brush.

### BRIEF DESCRIPTION OF THE DRAWINGS

Example embodiments of the present disclosure will be described hereinafter with reference to the accompanying drawings, in which:

FIG. 1 is a view illustrating a cushion frame for a vehicle seat according to a first embodiment;

FIG. 2 is a view illustrating the cushion frame for the vehicle seat according to the first embodiment;

FIG. 3 is an exploded view of an actuator according to the first embodiment;

FIG. 4 is a view illustrating the actuator according to the first embodiment;

FIG. 5 is a view illustrating the actuator according to the first embodiment;

FIG. 6 is a view illustrating a structure of the actuator according to the first embodiment;

FIG. 7 is a view illustrating the structure of the actuator according to the first embodiment; and

FIG. 8 is a partial exploded view of the actuator according to the first embodiment.

### DETAILED DESCRIPTION OF EXEMPLARY EMBODIMENT

Embodiments of the invention below show examples of embodiments within the technical scope of the present disclosure. In other words, invention-specifying matters and so on recited in the appended claims are not limited by specific configurations, structures, or the like indicated in the below-described embodiments.

The present embodiments are examples in which an electric actuator (hereinafter, abbreviated as “actuator”) according to the present disclosure is applied to a seat mounted in a vehicle such as a car (hereinafter, referred to as “vehicle seat”). Arrows indicating directions, hatched lines, and so on shown in the drawings are provided for the purpose of easier understanding of mutual relationships between the drawings, shapes of members or portions, and so on.

Thus, the actuator is not limited by the directions shown in the drawings. The directions shown in the drawings are directions in a state where the vehicle seat according to the present embodiment is mounted in the vehicle. The drawings with the hatched lines do not necessarily provide sectional views.

A member or portion described at least with a reference numeral is at least one in number except in a case of being accompanied by restrictive words such as “only one”. The actuator disclosed in the present disclosure comprises at least one of a constituent element such as a member or a portion described at least with a reference numeral or a structural part illustrated.

### First Embodiment

### 1. Overview of Vehicle Seat

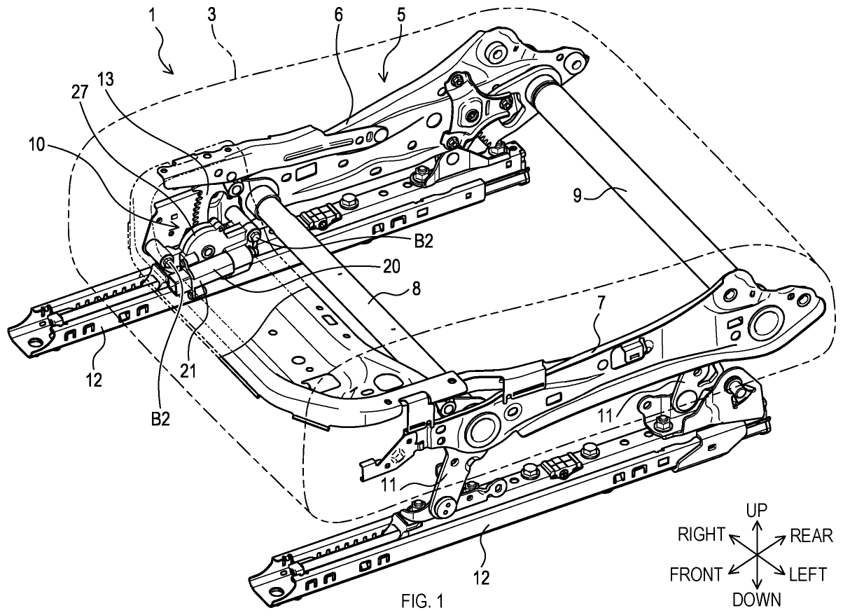

As illustrated in FIG. 1, a vehicle seat 1 comprises at least a seat cushion 3. The seat cushion 3 is a member to support buttocks of an occupant. The seat cushion 3 includes at least a cushion frame 5 and a lifter mechanism 10.

The cushion frame 5 forms a framework of the seat cushion 3. The cushion frame 5 includes at least two side frames 6 and 7, and two coupling members 8 and 9.

The two side frames 6 and 7 extend in seat front-rear directions at positions spaced apart from each other in seat-width directions. The two coupling members 8 and 9 extend in the seat-width directions and couple the side frame 6 and the side frame 7.

The lifter mechanism 10 is a mechanism that displaces the cushion frame 5 in a raising and lowering manner. The lifter mechanism 10 includes at least two or more lifter links 11 and an actuator 20. The lifter links 11 are one example of a movable portion of the vehicle seat.

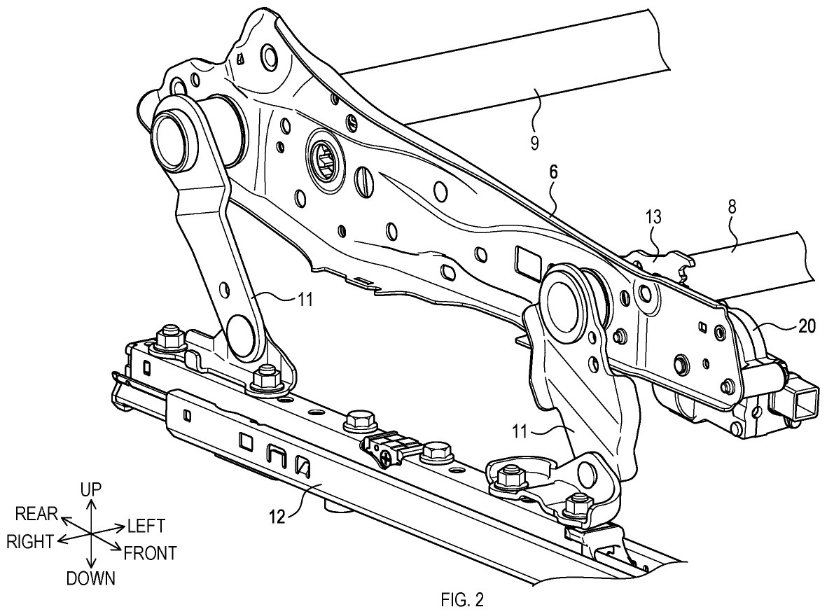

As illustrated in FIG. 2, the respective lifter links 11 are fixed to the coupling members 8 and 9 at upper ends thereof. The respective lifter links 11 are, at lower ends thereof, indirectly or directly fixed to a vehicle body in a rotatable manner with respect to the vehicle body.

In FIG. 2, the lower end of each lifter link 11 is indirectly fixed to the vehicle body via a sliding device 12. The sliding device 12 is a device slidably supporting the cushion frame 5, in other words, the vehicle seat 1.

The actuator 20 is a driving source that generates a moment of rotating each lifter link 11 about the lower end of the lifter link 11. In the present embodiment, the actuator 20 applies a rotational force to a sector gear 13, as illustrated in FIG. 1.

The sector gear 13 is fixed to the coupling member 8. If a rotational force is applied to the sector gear 13, then the coupling member 8 rotates, whereby the moment is generated on the lifter link 11 fixed to the coupling member 8. Thus, the cushion frame 5 is displaced to be raised or lowered.

### 2. Configuration of Actuator

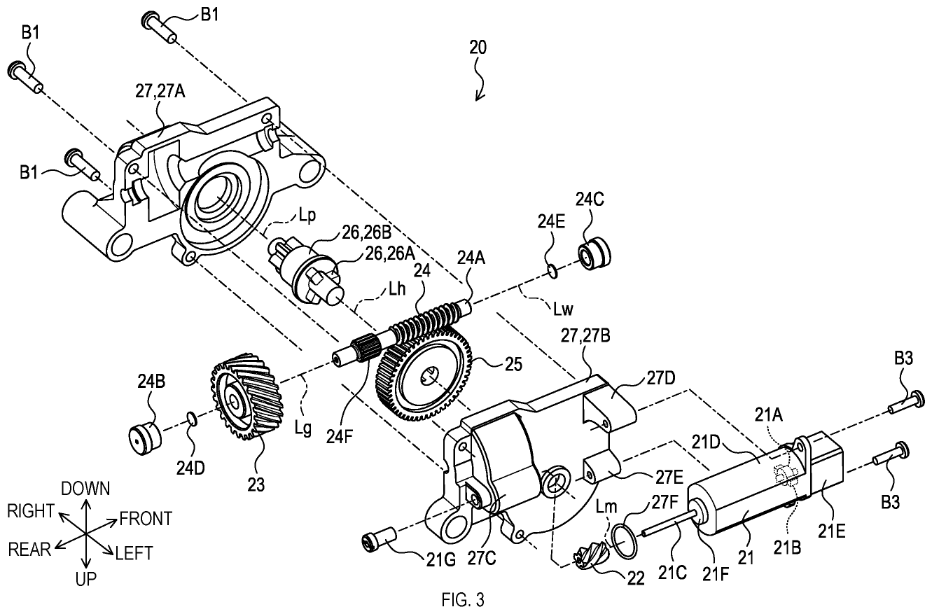

As illustrated in FIG. 3, the actuator 20 comprises at least an electric motor 21, a first gear 22, a second gear 23, a worm 24, a worm wheel 25, an output portion 26, and a gear casing 27.

In the present embodiment, the first gear 22, the second gear 23, the worm wheel 25, the output portion 26, and the gear casing 27 are made of resin; and the worm 24 is made of metal.

### <Electric Motor>

The electric motor 21 is an electric rotating device configured to generate a rotational force. The electric motor 21 according to the present embodiment is a direct current (DC) motor including a commutator 21A and a brush 21B. The commutator 21A and the brush 21B are arranged inside a motor main body 21D on an opposite side to an output shaft 21C.

The motor main body 21D is a part of the electric motor 21 accommodating a rotor coil (not shown) and a stator magnet (not shown). The commutator 21A rotates integrally with the rotor coil so as to switch polarities of an electric current flowing through the rotor coil.

The brush 21B makes slide contact with the commutator 21A so as to supply the commutator 21A with an electric current. There is provided a connector portion 21E on a brush 21B side with respect to the motor main body 21D. The connector portion 21E is coupled to a wiring harness (not shown) for the electric current to be supplied to the brush 21B.

### <First Gear and Second Gear>

The first gear 22 is a gear provided to the output shaft 21C of the electric motor 21 and rotates integrally with the output shaft 21C. The second gear 23 is a gear meshing with the first gear 22 and having a rotational axis Lg parallel to a rotational axis Lm of the output shaft 21C.

The first gear 22 and the second 23 according to the present embodiment are helical gears in which tooth-trace directions are oblique to the rotational axes Lm and Lg. Furthermore, the number of teeth of the first gear 22 in the present embodiment is set to four or less to increase a differential ratio between the first gear 22 and the second gear 23 to the greatest possible extent.

### <Worm and Worm Wheel>

The worm 24 is a threaded gear that rotates upon receipt of a driving force from the second gear 23, and has a rotational axis Lw parallel to the rotational axis Lm of the output shaft 21C. The worm 24 according to the present embodiment is integrated with the second gear 23 via an engagement portion 24F such as a spline or a serration.

Thus, the rotational axis Lw of the worm 24 coincides with the rotational axis Lg of the second gear 23, and the worm 24 rotates integrally with the second gear 23. That is, the second gear 23 has an angle of rotation (rotational frequency) coinciding with an angle of rotation (rotational frequency) of the worm 24.

The worm wheel 25 is a gear (a helical gear in the present embodiment) meshing with the worm 24 and having a rotational axis Lh parallel to a direction orthogonal to the rotational axis Lm of the output shaft 21C.

### <Output Portion>

The output portion 26 is a rotating part configured to receive a driving force from the worm wheel 25, to thereby output a rotational force. The output portion 26 has a rotational axis Lp parallel to a rotational axis Lh of the worm wheel 25. The output portion 26 according to the present embodiment rotates integrally with the worm wheel 25.

Specifically, the output portion 26 is provided with an engagement portion 26A. The engagement portion 26A is engaged with a rotation center of the worm wheel 25. Thus, the output portion 26 rotates integrally with the worm wheel 25 such that the rotational axis Lp and the rotational axis Lh coincide with each other.

Furthermore, the output portion 26 is provided with, on a leading end side thereof, a gear portion 26B meshing with the sector gear 13. As the output portion 26 rotates, the sector gear 13 rotates, and thus, the cushion frame 5 is displaced to be raised or lowered.

### <Gear Casing>

The gear casing 27 is a gear box accommodating the second gear 23, the worm 24, the worm wheel 25, and the output portion 26. The electric motor 21 is supported by the gear casing 27 such that the electric motor 21 is arranged outside the gear casing 27.

Specifically, the gear casing 27 comprises a first gear casing 27A and a second gear casing 27B, both of which are made of resin. The second gear 23, the worm 24, the worm wheel 25, and the output portion 26 are accommodated inside the gear casing 27 while being interposed between the first gear casing 27A and the second gear casing 27B.

The first gear casing 27A and the second gear casing 27B are fixed and fastened to each other with three bolts B1. The gear casing 27, that is, the actuator 20, is fixed to the side frame 6 with two bolts B2 (see, FIG. 1).

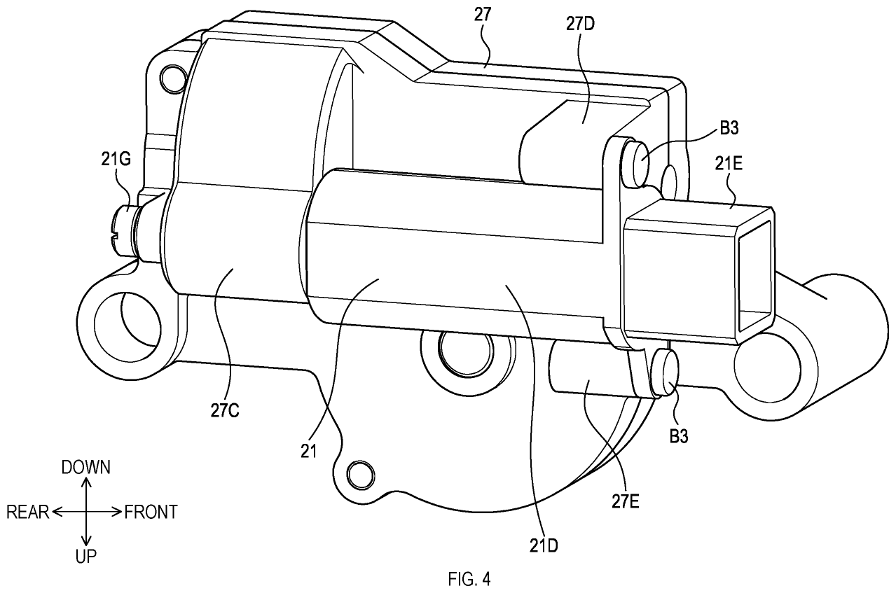

The second gear casing 27B is provided with a first support portion 27C and second support portions 27D and 27E. As illustrated in FIG. 4, the first support portion 27C supports the electric motor 21 on an output shaft 21C side. The second support portions 27D and 27E support the electric motor 21 on an opposite side to the output shaft 21C with respect to the motor main body 21D, that is, on a connector portion 21E side.

Among the first support portion 27C and the second support portions 27D and 27E, the first support portion 27C on the output shaft 21C side has an elastic support structure supporting the motor main body 21D via an elastic member 27F (see, FIG. 3). Specifically, the elastic member 27F according to the present embodiment is formed in a rubber-made annular body (an O-ring made of nitrile rubber in the present embodiment).

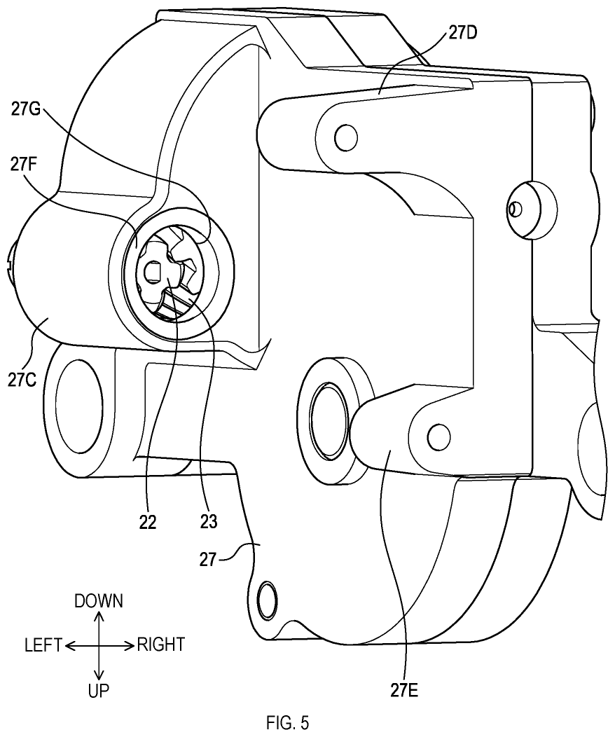

As illustrated in FIG. 5, the first support portion 27C includes a hole 27G through which the output shaft 21C is inserted. The elastic member 27F is fitted in the hole 27G. A boss 21F (see, FIG. 3) of the motor main body 21D is fitted in the elastic member 27F in the form of the O-ring.

Consequently, the motor main body 21D is elastically supported by the first support portion 27C on the output shaft 21C side. As illustrated in FIG. 4, on the connector portion 21E side, the motor main body 21D is fixed to the second support portions 27D and 27E with bolts B3 such as P-type screws.

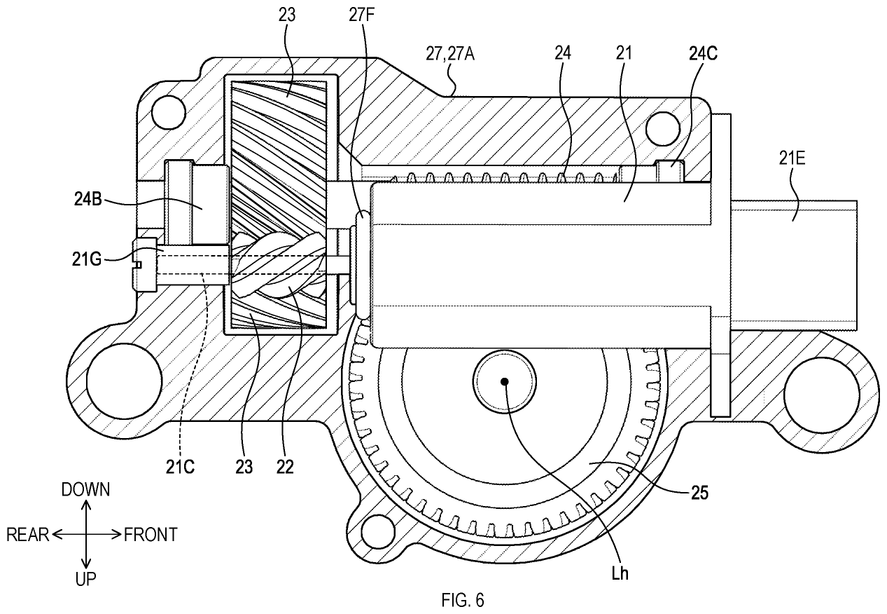

As illustrated in FIG. 6, at least a part of the electric motor 21 projected on an imaginary plane orthogonal to the rotational axis Lh of the worm wheel 25 overlaps at least one of the worm 24 projected on the imaginary plane or the worm wheel 25 projected on the imaginary plane.

### <Bearing Structure>

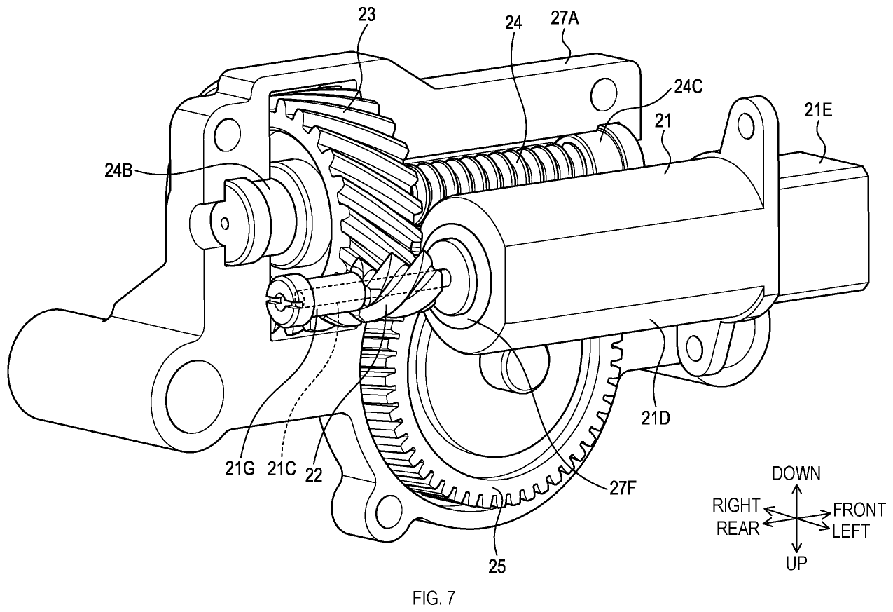

As illustrated in FIG. 7, a shaft 24A (see, FIG. 3) of the worm 24 is rotatably supported by the gear casing 27 via slide bearings 24B and 24C. The slide bearing 24B rotatably supports a second gear 23 side of the shaft 24A. The slide bearing 24C rotatably supports a side of the shaft 24A opposite to the second gear 23 with respect to the worm 24.

There are arranged disk-like spacers 24D and 24E (see, FIG. 3), respectively, between the slide bearing 24B and the shaft 24A, and between the slide bearing 24C and the shaft 24A. The spacers 24D and 24E are slide thrust bearings that receive a thrust load (axial load) to be generated as the worm 24 rotates.

As illustrated in FIG. 7, there is arranged a slide bearing 21G on the leading end side of the output shaft 21C. The slide bearing 21G is press-fitted and fixed to the gear casing 27, and rotatably supports the leading end side of the output shaft 21C.

A thrust load to be generated on the output shaft 21C due to meshing between the first gear 22 and the second gear 23 is sufficiently smaller than a thrust load to be generated on the shaft 24A of the worm 24. Thus, the thrust load acting on the output shaft 21C is received by a slide thrust bearing (not shown) arranged inside the motor main body 21D.

### 3. Features of Actuator According to Present Embodiment

As illustrated in FIG. 6, the actuator 20 according to the present embodiment is configured such that the at least a part of the electric motor 21 projected on the imaginary plane overlaps at least one of the worm 24 projected on the imaginary plane or the worm wheel 25 projected on the imaginary plane. Thus, the actuator 20 has outer dimensions smaller than the outer dimensions of the actuator disclosed in Patent Document 1.

Specifically, the actuator disclosed in Patent Document 1 is configured such that the electric motor is arranged on an opposite side to the worm wheel across the worm (see, FIG. 1 of Patent Document 1). In contrast, in the actuator 20 according to the present embodiment, the electric motor 21 is not situated on an opposite side to the worm wheel 25 across the worm 24 as illustrated in FIG. 6. Therefore, the actuator 20 according to the present embodiment has the smaller outer dimensions at least in up-down directions in FIG. 6 as compared to the outer dimension of the actuator disclosed in Patent Document 1.

As illustrated in FIG. 4, the electric motor 21 is supported by the gear casing 27 such that the electric motor 21 is arranged outside the gear casing 27. This allows easier thermal dissipation when heat is generated in the electric motor 21 as compared to a configuration of accommodating the electric motor 21 inside the gear casing 27.

Therefore, the heat is inhibited from being accumulated inside the gear casing 27, thereby enabling inhibition of thermal degradation of lubricant such as grease or the like encapsulated inside the gear casing 27.

Most components of the electric motor 21 including the rotor, the rotor coil, the stator, and the motor casing are made of metal, whereas the components in the present embodiment excluding the worm 24, that is, the second gear 23, the worm wheel 25, the output portion 26, the gear casing 27, etc., are made of resin. Thus, the electric motor 21 has a greater mass than a mass of a part corresponding to the gear casing 27.

In the present embodiment, the first support portion 27C and the second support portions 27D and 27E, all of which support the electric motor 21, are located on the output shaft 21C side with respect to the motor main body 21D and on the opposite side to the output shaft 21C with respect to the side of the motor main body 21D, respectively.

Such an arrangement allows a configuration where the electric motor 21 having a relatively large mass is supported on one side and on the other side of the motor main body 21D. Consequently, this configuration can suppress excessive increase in (i) a maximum vibration amplitude of vibration generated in the electric motor 21 and (ii) a maximum vibration amplitude of the electric motor 21 when the electric motor 21 vibrates due to an exciting force applied to the electric motor 21 from an outside via the vehicle seat.

Among the first support portion 27C and the second support portions 27D and 27E, the first support portion 27C on the output shaft 21C side supports the motor main body 21D via the elastic member 27F. Consequently, dimensional variations of the first support portion 27C and the second support portions 27D and 27E and the above vibrations can be absorbed.

The leading end side of the output shaft 21C is rotatably supported by the slide bearing 21G fixed to the gear casing 27. Such a configuration can ensure that the first gear 22 and the second gear 23 remain properly meshing with each other over a long period of time.

In the electric motor 21, the commutator 21A and the brush 21B are arranged on the opposite side to the output shaft 21C. Consequently, even if the lubricant encapsulated inside the gear casing 27 enters the motor main body 21D, it can be inhibited from reaching the commutator 21A and the brush 21B.

### Second Embodiment

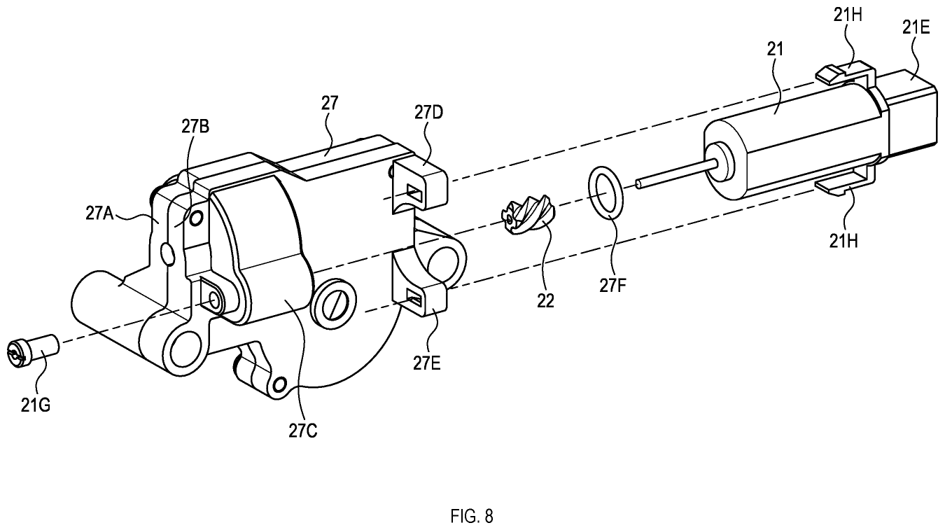

In the above-described embodiment, on the connector portion 21E side, the motor main body 21D is fixed to the second support portions 27D and 27E with the bolts B3 (see, FIG. 4). In contrast, the actuator 20 according to the present embodiment is configured, as illustrated in FIG. 8, such that the motor main body 21D is fixed to the second support portions 27D and 27E with lock portions 21H of a snap-fit type on the connector portion 21E side.

The same constituent features and the like as in the above-described embodiment are denoted with the same reference numerals as in the above-described embodiment. Therefore, overlapping descriptions are omitted in the present embodiment.

### OTHER EMBODIMENTS

The above-described embodiments are examples in which the actuator 20 according to the present embodiment is applied to the lifter mechanism 10. However, the present disclosure is not limited hereto. Specifically, the present disclosure can be applied to, for example, an actuator for an electric recliner and a tilting device.

In the above-described embodiments, the electric motor 21 is arranged outside the gear casing 27. However, the present disclosure is not limited hereto. Specifically, the present disclosure may have a configuration of, for example, arranging the electric motor 21 inside the gear casing 27.

In the above-described embodiments, the first support portion 27C and the second support portions 27D and 27E, all of which support the electric motor 21, are arranged on the output shaft 21C side and the connector 21E portion side, respectively. However, the present disclosure is not limited hereto. Specifically, the present disclosure may have a configuration of, for example, providing only the support portion 21C on the output shaft 21C side.

In the above-described embodiments, the electric motor 21 is elastically supported. However, the present disclosure is not limited hereto. Specifically, in the present disclosure, the electric motor 21 may be fixed to the first support portion 27C in a rigid manner not via any elastic member, for example.

In the above-described embodiments, the leading end side of the output shaft 21C is rotatably supported by the slide bearing 21G fixed to the gear casing 27. However, the present disclosure is not limited hereto. Specifically, for example, the present disclosure may have a configuration of eliminating the slide bearing 21G.

In the above-described embodiments, the electric motor 21 is configured such that the commutator 21A and the brush 21B are arranged on the opposite side to the output shaft 21C. However, the present disclosure is not limited hereto. Specifically, for example, the present disclosure may have a configuration of arranging the commutator 21A and the brush 21B on the same side as the output shaft 21C.

The first gear 22 and the second gear 23 according to the above-described embodiments are helical gears having the tooth-trace directions oblique to the rotational axes Lm and Lg. However, the present disclosure is not limited hereto. Specifically, for example, the present disclosure may use spur gears having tooth-trace directions parallel to the rotational axes Lm and Lg.

The slide bearing 21G according to the above-described embodiments is press-fitted and fixed to the gear casing 27. However, the present disclosure is not limited hereto. Specifically, for example, the present disclosure may have a configuration in which an outer circumference of the slide bearing 21G is provided with a male screw and the slide bearing 21G is fixed to the gear casing 27 with the male screw.

In the above-described embodiments, the vehicle seat according to the present disclosure is applied to a vehicle. However, application of the invention disclosed herein should not be limited hereto. Specifically, for example, the present disclosure can be applied to seats used in other vehicles, such as railway vehicles, ships and boats, and aircrafts, and to stationary seats used in theaters and households.

Furthermore, the present disclosure only has to be consistent with ideas of the present disclosure specified in the above-described embodiments, and is not limited to the above-described embodiments. Therefore, the present disclosure may be configured in combination of at least two embodiments of the above-described embodiments or may be configured so as to eliminate any of the illustrated constituent elements or the constituent elements described with reference numerals in the above-described embodiments.

What is claimed is:

1. An electric actuator for operating a movable portion of a vehicle seat, the electric actuator comprising:
an electric motor;
a first gear provided to an output shaft of the electric motor;
a second gear meshing with the first gear, the second gear having a rotational axis parallel to a rotational axis of the output shaft;
a worm configured to receive a driving force from the second gear to thereby rotate, the worm having a rotational axis parallel to the rotational axis of the output shaft;
a worm wheel meshing with the worm, the worm wheel having a rotational axis parallel to a direction orthogonal to the rotational axis of the output shaft; and
an output portion configured to receive a driving force from the worm wheel to thereby output a rotational force, the output portion having a rotational axis parallel to the rotational axis of the worm wheel,
at least a part of the electric motor projected on an imaginary plane orthogonal to the rotational axis of the worm wheel overlapping at least one of the worm projected on the imaginary plane or the worm wheel projected on the imaginary plane.

2. The electric actuator according to claim 1, further comprising a gear casing accommodating therein the second gear, the worm, and the worm wheel,
wherein the electric motor is supported by the gear casing such that the electric motor is arranged outside the gear casing.

3. The electric actuator according to claim 2, further comprising two or more support portions supporting the electric motor, the two or more support portions comprising a first support portion arranged on an output shaft side with respect to a motor main body of the electric motor and a second support portion arranged on an opposite side to the output shaft with respect to the motor main body.

4. The electric actuator according to claim 3, wherein the first support portion supports the motor main body via an elastic member.

5. The electric actuator according to claim 2, further comprising a slide bearing rotatably supporting a leading end side of the output shaft, the slide bearing being fixed to the gear casing.

6. The electric actuator according to claim 3, further comprising a slide bearing rotatably supporting a leading end side of the output shaft, the slide bearing being fixed to the gear casing.

7. The electric actuator according to claim 4, further comprising a slide bearing rotatably supporting a leading end side of the output shaft, the slide bearing being fixed to the gear casing.

8. The electric actuator according to claim 3, wherein the electric motor is a direct current motor comprising a commutator and a brush inside the motor main body on an opposite side to the output shaft with respect to the motor main body.

9. The electric actuator according to claim 4, wherein the electric motor is a direct current motor comprising a commutator and a brush inside the electric motor main body on an opposite side to the output shaft with respect to the motor main body.
